(19) United States
(12) Patent Application Publication
(10) Pub. No.: US 2015/0375136 A1
(43) Pub. Date: Dec. 31, 2015

(54) ESSENTIAL OIL DISTILLATION SYSTEMS, DEVICES, AND METHODS

(71) Applicant: Lew Swan, Gresham, OR (US)

(72) Inventor: Lew Swan, Gresham, OR (US)

(21) Appl. No.: 14/603,093

(22) Filed: Jan. 22, 2015

Related U.S. Application Data
(63) Continuation of application No. PCT/US14/44336, filed on Jun. 26, 2014.

(51) Int. Cl. B01D 3/40; C11B 9/02

(52) U.S. Cl. CPC B01D 3/40; C11B 9/027; C11B 9/025

(57) ABSTRACT

Essential oil distillation systems and methods for purifying an essential oil from plant material are shown and described. Each of the example essential oil distillation systems includes a material chamber configured to receive plant material and a solvent, a combination of the plant material and the solvent forming an essential oil, contaminant, and solvent mixture; a temperature regulating sleeve configured to be cooled to decrease a temperature of the mixture and freeze one or more contaminants in the mixture; at least one filter configured to filter the one or more contaminants from the mixture to separate a solvent and essential oil solution from the one or more contaminants; and a recovery chamber fluidly coupled to a downstream end of the material chamber, the recovery chamber configured to receive the solvent and essential oil solution.

### CROSS REFERENCE TO RELATED APPLICATIONS

This application claims priority to copending International Patent Application Serial No. PCT/US14/44336, filed on Jun. 26, 2014, which is hereby incorporated by reference for all purposes.

### BACKGROUND

The present disclosure relates generally to systems, devices, and methods for essential oil distillation. In particular, system, devices, and methods for essential oil distillation that utilize temperature regulating chamber sleeves are described.

Essential oils are concentrated hydrophobic liquids containing compounds extracted from plant material. Distillation systems and methods can be used to separate an essential oil from raw plant matter using a solvent. Distillation systems and methods separate compounds (e.g., plant matter and essential oil) based on their relative solubilities in an organic solvent (e.g., butane, naphtha, petroleum ether, hexane, benzene, etc.). Essential oils are used in perfumes, cosmetics, soaps, incense, household cleaning products, flavoring in food and drink, and medicinal purposes. Thus, it is desirable for essential oils, especially for essential oils intended for consumption and/or medicinal purposes, to have a high degree of purity (i.e., be free of contaminants).

Known distillation systems and methods are not entirely satisfactory for the range of applications in which they are employed. For example, existing distillation systems and methods can have a high degree of impurities (e.g., plant matter, debris, etc.) that contaminate the essential oil. Moreover, conventional distillation systems and methods can require complex procedures and/or multiple distillations to obtain a purified product that is of a high enough quality for use (e.g., consumption, burning, medicinal purposes, etc.). In addition, conventional distillation systems and methods can release high levels of hazardous fumes (e.g., fumes from the organic solvent) during the distillation process.

Thus, there exists a need for distillation systems and methods that improve upon and advance the design of known distillation systems and methods. Examples of new and useful essential oil distillation systems, devices, and methods relevant to the needs existing in the field are discussed below.

### SUMMARY

The present disclosure is directed to essential oil distillation systems and methods for purifying an essential oil from plant material using the described systems. Each of the example essential oil distillation systems includes a material chamber configured to receive plant material and a solvent, a combination of the plant material and the solvent forming an essential oil, contaminant, and solvent mixture; a temperature regulating sleeve configured to be cooled to decrease a temperature of the oil, contaminant, and solvent mixture and freeze one or more contaminants in the oil, contaminant, and solvent mixture; at least one filter configured to filter the one or more contaminants from the essential oil, contaminant, and solvent mixture to separate a solvent and essential oil solution from the one or more contaminants; and a recovery chamber fluidly coupled to a downstream end of the material chamber, the recovery chamber configured to receive the solvent and essential oil solution.

### BRIEF DESCRIPTION OF THE DRAWINGS

FIG. 1 is a perspective view of a first example of an essential oil distillation system including a temperature regulating sleeve around a first example material chamber.

FIG. 2 is a cross-sectional view of the first example of an essential oil distillation system shown in FIG. 1 during an extraction process.

FIG. 3 is a cross-sectional view of the first example of an essential oil distillation system shown in FIG. 1 during a solvent removal process.

FIGS. 4A-4C are side elevation, top plan, and bottom plan views, respectively, of the first example material chamber for the essential oil distillation system of FIG. 1.

FIG. 5 is a perspective view of a second example of an essential oil distillation system including a temperature regulating sleeve around a gas chamber, a material chamber, and a recovery chamber.

FIG. 6 is a cross-sectional view of the second example of an essential oil distillation system shown in FIG. 5 during an extraction process.

FIG. 7 is a cross-sectional view of the second example of an essential oil distillation system shown in FIG. 5 during a solvent removal process.

FIGS. 8A-8C are side elevation, top plan, and bottom plan views, respectively, of the gas chamber for the essential oil distillation system of FIG. 5.

FIGS. 9A-9C are side elevation, top plan, and bottom plan views, respectively, of the recovery chamber for the essential oil distillation system of FIG. 5.

FIGS. 10A-10C are top plan, side elevation, and bottom plan views, respectively, of a temperature regulating coil for a second example material chamber for use with either of the first or the second example essential oil distillation systems.

FIGS. 10D-10F are top plan, side elevation, and bottom plan views, respectively, of a sleeve and material chamber for the temperature regulating coil of the second example material chamber shown in FIGS. 10A-10C.

FIGS. 11A-C are top plan, side elevation, and bottom plan views, respectively, of a third example material chamber for use with either of the first or the second example essential oil distillation systems.

FIGS. 11D-F are top plan, side elevation, and bottom views, respectively, of a filter for the third example material chamber shown in FIGS. 11A-11C.

FIG. 12 is a flow chart showing an example method for essential oil distillation, and alternative solvent removal methods via passive solvent removal (using the second example essential oil distillation system shown in FIG. 5) and active solvent removal (using either of the first or the second example essential oil distillation systems shown in FIGS. 1 and 5, respectively).

### DETAILED DESCRIPTION

The disclosed essential oil distillation systems, devices, and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various essential oil distillation systems, devices, and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

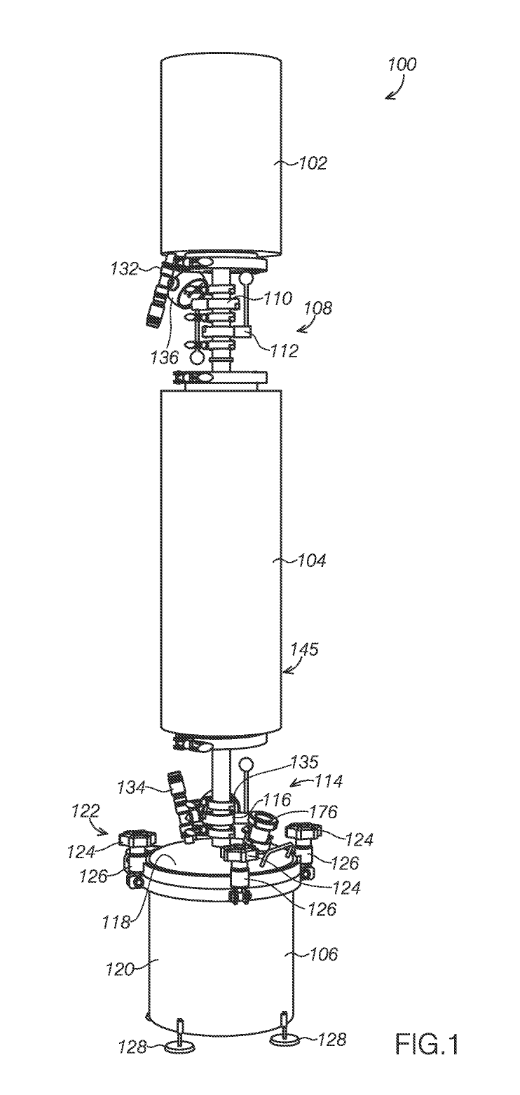

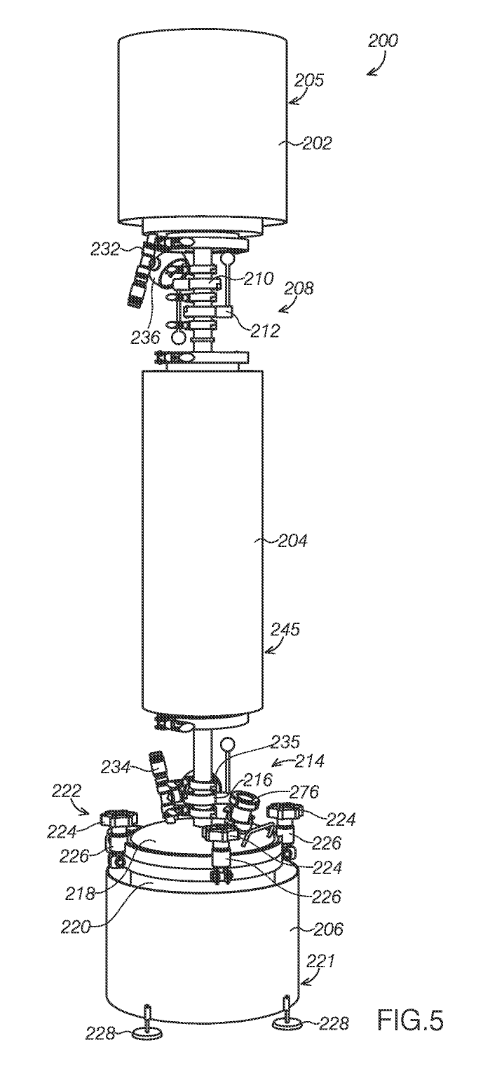

With reference to FIGS. 1-12, a first example oil distillation system, distillation system 100 (FIGS. 1-4 and 10-12), and a second example oil distillation system, distillation system 200 (FIGS. 5-12), are shown and described. Each of distillation systems 100 and 200 include a temperature regulating sleeve encompassing an outer surface of a material chamber for regulation of the temperature of the material chamber during oil distillation. Further, distillation system 200 includes additional temperature regulating sleeves around a gas chamber and a recovery chamber for temperature regulation during passive solvent removal.

Distillation systems 100 and 200 function to efficiently separate an essential oil from plant material using a solvent (e.g., butane, N-butane, hexane, alcohol, liquid oxygen, liquid nitrogen, liquid carbon dioxide, etc.) by rapidly freezing a solvent and plant matter mixture (i.e., an essential oil, contaminant, and solvent mixture), and then passing the mixture through a filter to remove the one or more contaminants. Additionally or alternatively, distillation systems 100 and 200 can be used to recover the solvent after distillation (e.g., passive solvent removal, active solvent removal, etc.) in order to isolate a purified essential oil.

Distillation systems 100 and 200 address many of the shortcomings existing with conventional essential oil distillation systems and methods. For example, using the presently described systems and methods yields a higher purity of essential oil (i.e., decreased concentration of contaminants) than conventional distillation systems and methods. In another example, using distillation systems 100 and 200, the recovery chamber and the gas chamber can be fluidly coupled after extraction. In this example, solvent can be returned directly to the gas chamber, thereby preventing release of the majority of solvent fumes into the atmosphere during solvent removal. Further, the solvent can be reused in subsequent extractions.

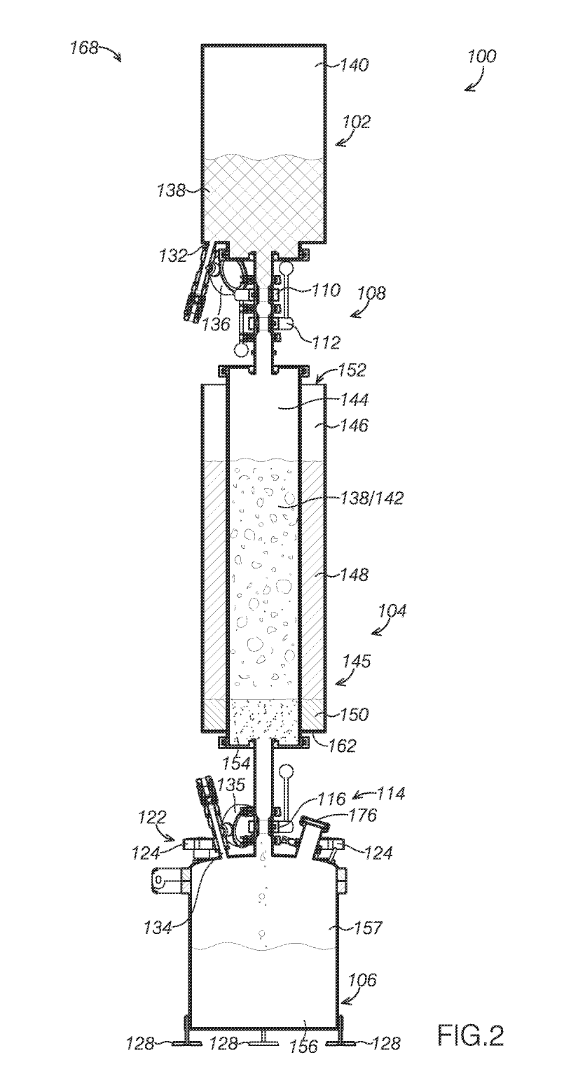

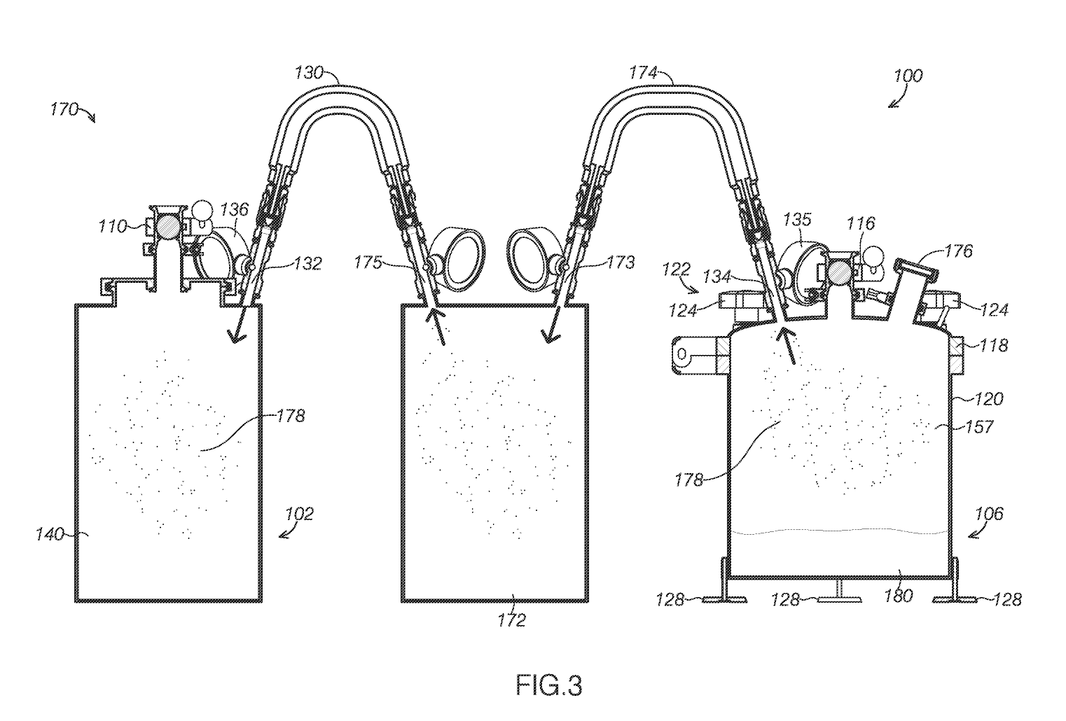

Specifically, as shown in FIGS. 1 and 2, the first example of an essential oil distillation system, distillation system 100, includes a gas chamber 102, a material chamber 104, and a recovery chamber 106. In the present configuration, material chamber 104 is downstream of gas chamber 102 and recovery chamber 106 is downstream of material chamber 104. In the present example, each of the gas, the material, and the recovery chambers are each cylindrical and comprised of stainless steel. Further, in the present example, material chamber 104 includes a temperature regulating sleeve 145 (depicted in FIGS. 2 and 3A-3C).

In alternative examples, the distillation system can include a secondary material chamber downstream of material chamber 104 (i.e., the primary material chamber) and upstream of recovery chamber 106. In one specific alternative example, the primary material chamber can exclude a temperature regulating sleeve and the secondary material chamber can include a temperature regulating sleeve. In another specific alternative example, each of the primary and the secondary material chambers can include a temperature regulating sleeve. Further, one or more of the gas, the material (i.e., primary and/or secondary), and the recovery chambers can have a different shape (e.g., cubical, rectangular cuboidal, etc.) and/or be comprised of a different material suitable for exposure to temperature changes and exposure to a solvent (e.g., titanium, etc.).

As depicted in FIGS. 1 and 2, an upstream coupling mechanism 108 including a first valve 110 and a second valve 112 is disposed between gas chamber 102 and material chamber 104 for selectively allowing fluid communication between the gas chamber to the material chamber (i.e., fluidly coupling the gas chamber and the material chamber). A downstream coupling mechanism 114 including a valve 116 is disposed between material chamber 104 and recovery chamber 106 for selectively allowing fluid communication between the material chamber to the recovery chamber (i.e., fluidly coupling the material chamber and the recovery chamber).

In the present example, each of the valves are ball valves. It will be appreciated that in alternative embodiments the upstream coupling mechanism can include more or fewer valves (e.g., 1, 3, etc.) and the downstream coupling mechanism can include more valves (e.g., 2, 3, etc.). Additionally or alternatively, one or more of the valves can be any type of valve known or yet to be discovered that is suitable for selective fluid communication (e.g., ball valve, check valve, diaphragm valve, gate valve, globe valve, needle valve, plug valve, etc.).

As shown in FIGS. 1-3, recovery chamber 106 includes a lid 118 that is selectively coupled to a receptacle 120 via a tightenable and releasable attachment mechanism 122. In the present example, attachment mechanism 122 includes four threaded members 124 (only three threaded members are visible in the view of FIG. 1) that are rotatably attached to receptacle 120 and are fitted into complimentarily configured channels 126 on a periphery of lid 118. Recovery chamber 106 further includes four foot members 128 (only two are visible in the view of FIG. 1) attached at a bottom edge periphery of receptacle 120.

In alternate examples, the lid can be attached via a different attachment mechanism (e.g., an outer edge threaded lid can be selectively tightenable and releasable within a complimentarily configured inner top edge of the receptacle, the receptacle can include selectively rotatable compression members that engage of lip edge of the lid, etc.). Additionally or alternatively, in other examples, the recovery chamber can include more or fewer foot members and/or include an alternate type of foot member (e.g., one or more cushioned pads attached to a bottom surface of the recovery chamber, etc.).

A hose 130 can be attached to a port 132 in gas chamber 102 and a port 134 in recovery chamber 106 for fluid coupling of the gas chamber and the recovery chamber (shown in FIG. 3). A pressure gauge 136 is coupled to port 132 for measuring an internal pressure of gas chamber 102 and a pressure gauge 135 is coupled to port 134 for measuring an internal pressure of recovery chamber 106.

As depicted in FIG. 2, during an extraction process 168, the gas, the material, and the recovery chambers are vertically arranged and gravity may act to pull liquids through the system. Accordingly, gas chamber (102 is configured to receive and/or retain a liquid solvent 138 (e.g., butane, N-butane, hexane, alcohol, liquid oxygen, liquid nitrogen, liquid carbon dioxide, etc.) in an internal space 140, and is further configured to selectively dispense solvent 138. Solvent 138 can be fed into gas chamber 102 through hose 130 and/or port 132 (i.e., hose 130 can be removed and/or uncoupled from recovery chamber 106). Valves 110 and 112 are configured to regulate a flow of solvent 138 from gas chamber 102 to material chamber 104.

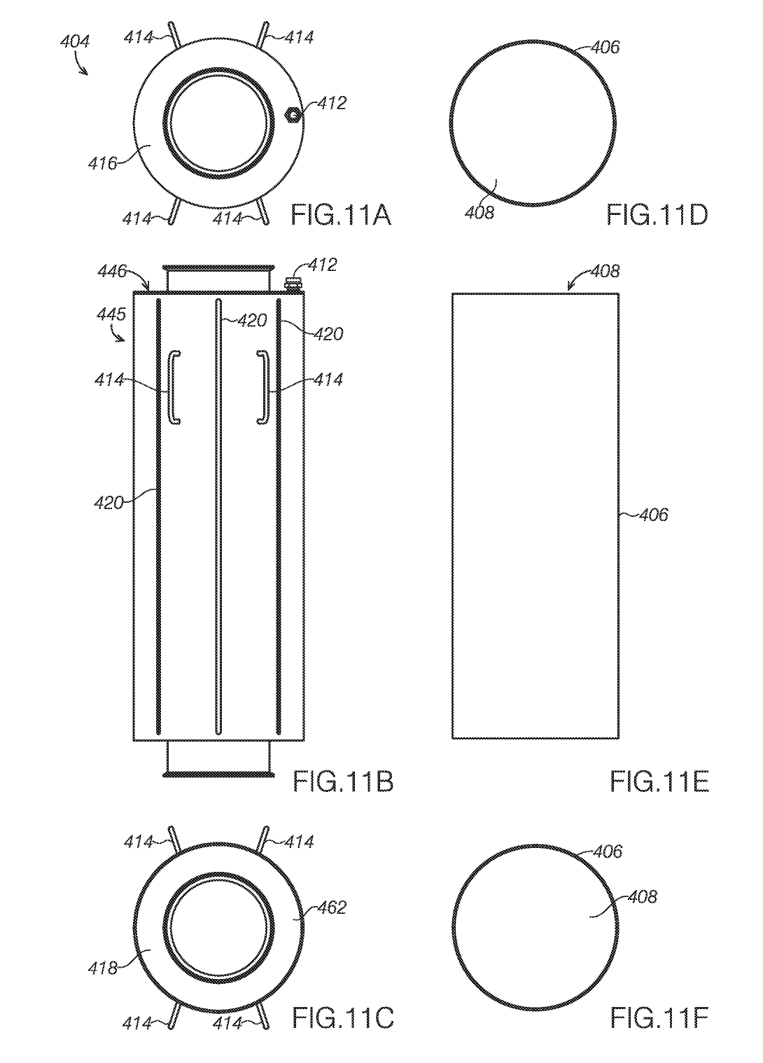

Material chamber 104 is configured to receive and retain raw material 142 (e.g., plant material) in an internal space 144. Further, material chamber 104 is configured to receive solvent 138 from gas chamber 102 and form a mixture of solvent 138 and raw material 142 (i.e., an essential oil, contaminant, and solvent mixture). During extraction process 168, the mixture of solvent 138 and raw material 142 can be incubated in material chamber 104 for any desired length of time (described later in reference to FIG. 11).

Further, material chamber 104 includes sleeve 145 having an external space 146. Sleeve 145 is configured to regulate a temperature of material chamber 104 (i.e., a temperature within internal space 144). Accordingly, external space 146 is configured to receive and retain a temperature regulating material, such as a coolant 148 (e.g., solid carbon dioxide, liquid nitrogen, etc.) and/or a carrier solution 150 (e.g., liquid water, ethylene glycol, acetone, alcohol, etc.) for cooling material chamber 104 to a freezing temperature in order to freeze plant matter and/or debris in the raw material and solvent mixture. In alternate examples, the sleeve can be filled with a malleable heating material (e.g., hot water, hot sand, hot glycerin, hot buckwheat, etc.) for increasing the temperature of the material chamber.

In the present example, external space 146 is open to the environment and has an opening 152 at a top of external space 146 and sleeve 145 for addition/insertion of temperature regulating materials. In alternate examples, the external space can be closed and include a port for addition of temperature regulating materials and/or release of gas.

Furthermore, material chamber 104 includes a filter 154 disposed at a downstream end (i.e., at a bottom end) within internal space 144. Filter 154 is configured to filter and/or retain one or more contaminants (e.g., debris, plant matter, frozen plant matter particles, etc.) from the essential oil, contaminant, and solvent mixture, and permit passage of an oil and solvent solution 156 into recovery chamber 106. In other words, the filter is configured to separate a solvent and oil mixture from contaminants.

In one specific example, the filter is 154 mesh stainless steel screen. In alternate examples, the material chamber can include more than one filter and/or the one or more filters can be comprised of a different filtration material (e.g., diatomaceous earth, paper, carbon charcoal, graphite, etc.). In examples where distillation system 100 includes a secondary material chamber, one or more filters may be disposed at one or both of the upstream end and the downstream end of the secondary material chamber.

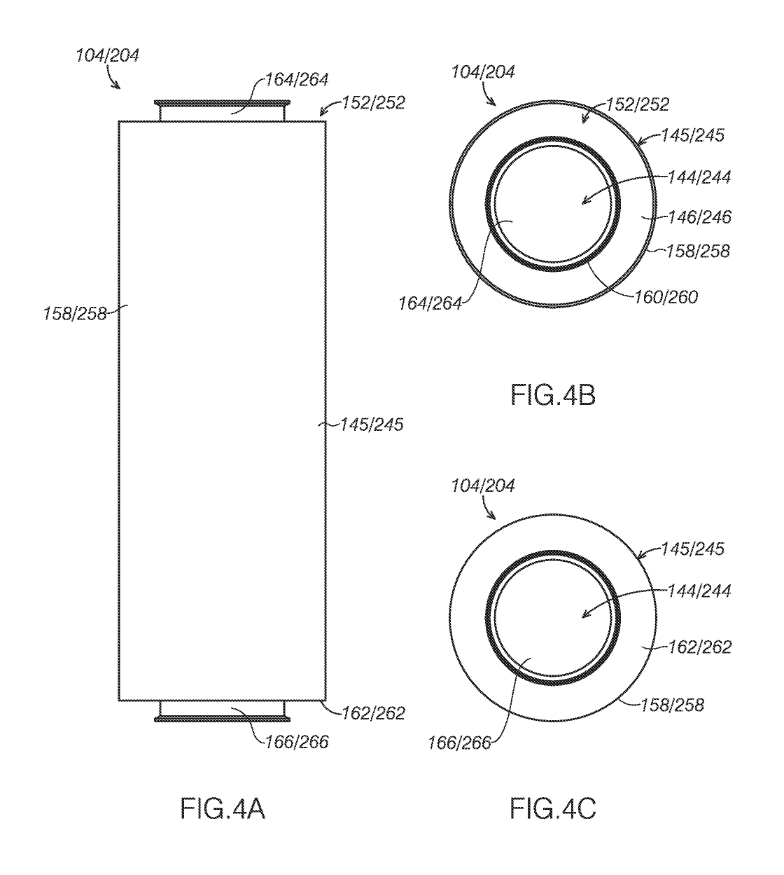

Detailed views of material chamber 104 are shown in FIGS. 4A-4C. Material chamber 104 includes an outer wall 158 that defines an outer periphery of sleeve 145 and opening 152. An internal wall 160 defines an outer periphery of internal space 144 and an inner wall of sleeve 145. On an opposing end of external space 146 relative to opening 152, material chamber 104 includes a floor 162 of sleeve 145. An upstream coupling region 164 and a downstream coupling region 166 of material chamber 104 are extended beyond sleeve 145 (i.e., extended beyond opening 152 and floor 162, respectively).

Returning to FIG. 2, recovery chamber 106 is configured to receive oil and solvent solution 156 from material chamber 104. Oil and solvent solution 156 is received and retained within internal space 157. Valve 116 is configured to regulate a flow of oil and solvent solution 156 from material chamber 104 to recovery chamber 106. During solvent removal (i.e., solvent removal process 170 shown in FIG. 3), the solvent can be removed from the oil and solvent solution via evaporation and returned to the gas chamber via hose 130 and/or vented into a fumigation hood via port 134 (i.e., in an example excluding hose 130).

As shown in FIG. 3, the gas chamber and the recovery chamber can be uncoupled from the material chamber, the gas chamber can be inverted, and the gas chamber and the recovery chamber can be horizontally aligned during an active solvent removal process 170 via attachment to a pump system 172 (active solvent removal is described in detail in reference to FIG. 11). Hoses 130 and 174 are configured to fluidly couple gas chamber 102 to pump system 172 and pump system 172 to recovery chamber 106, respectively, for transfer of solvent fumes 178 (i.e., solvent vapors) from recovery chamber 106 to gas chamber 102 during active solvent removal.

In one specific example, the hoses includes a quick disconnect male coupling partner and each of the ports (e.g., ports 132, 134, 173, and 175) are quick disconnect female coupling partners. In this example, a slider can be moved outward on the female coupling partner to move an internal bearing out of a central channel of the female coupling partner. The male coupling partner can then be inserted into the central channel of the female coupling partner. When the male coupling partner is connected to the female coupling partner the bearings and the slider are biased to return towards an uncoupled position. The bearings are then abutted to a ridge on the male coupling partner. Once the ridge is slid past the bearings, the slider shuts via a spring, thereby locking the male coupling partner into the female coupling partner. A plug inside of the female coupling partner is pushed with a backpressure spring so that the connection pathway is opened and liquid and/or gases can pass freely through the coupled male and female coupling partners. The male and female coupling partners can be selectively uncoupled and/or released to close the ports and prevent movement of liquids and/or gases out of the chambers.

Pump system 172 is configured to pump solvent fumes 178 (i.e., solvent vapors) from recovery chamber 106 to gas chamber 102. Active solvent process 170 is characterized as “active” because it requires a pump system for solvent removal. During active solvent removal 170, pressure gauge 136 (coupled to port 132) measures an internal pressure of gas chamber 102 and pressure gauge 135 (coupled to port 134) measures an internal pressure of recovery chamber 106. In alternate examples, where the gas chamber is not used for solvent fume collection (e.g., residual solvent is released into a fumigation hood, etc.), the hoses and/or the pump system can be excluded. After transfer of solvent fumes 178, a purified essential oil 180 (i.e., an end product) remains in recovery chamber 106 and solvent 178 is collected in gas chamber 102. The purified essential oil can be collected from the recovery chamber and/or the solvent in the gas chamber can be reused in subsequent extraction procedures.

Turning attention to FIGS. 5-9C, the second example of an essential oil distillation system, distillation system 200, will now be described. Distillation system 200 includes many similar or identical features to distillation system 100). Thus, for the sake of brevity, each feature of distillation system 200 will not be redundantly explained. Rather, key distinctions between distillation system 200 and distillation system 100 will be described in detail and the reader should reference the discussion above for features substantially similar between the two distillation systems.

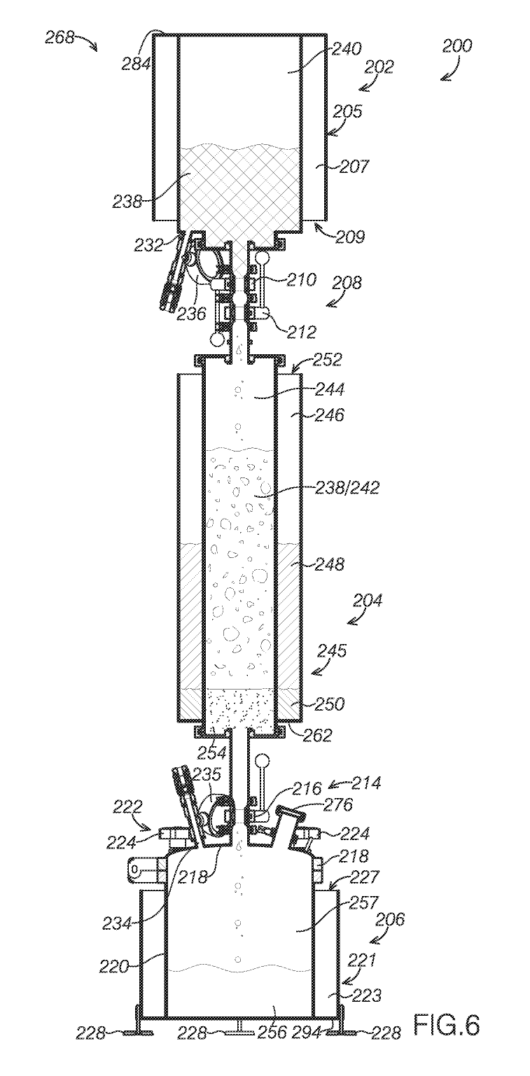

As depicted in FIGS. 5 and 6, distillation system 200 includes a gas chamber 202, a material chamber 204, and a recovery chamber 206. In the present configuration, material chamber 204 is downstream of gas chamber 202 and recovery chamber 206 is downstream of material chamber 204. In the present example, each of the gas, the material, and the recover chambers are comprised of stainless steel. Further, in the present example, material chamber 204 that is substantially identical to material chamber 104 and includes a temperature regulating sleeve 245 (depicted in FIGS. 5, 6, and 3A-3C). Furthermore, in the present example the gas chamber 202 includes a temperature regulating sleeve 205 (depicted in FIGS. 5-7 and 8A-8C) and recovery chamber 206 includes a temperature regulating sleeve 221 (depicted in FIGS. 5-7 and 9A-9C).

In alternative examples, the distillation system can include a secondary material chamber downstream of material chamber 204 (i.e., the primary material chamber) and upstream of recovery chamber 206. In one specific alternative example, the primary material chamber can exclude a temperature regulating sleeve and the secondary material chamber can include a temperature regulating sleeve. In another specific alternative example, each of the primary and the secondary material chambers can include a temperature regulating sleeve. Further, one or more of the gas, the material (i.e., primary and/or secondary), and the recovery chambers can be comprised of a different material suitable for exposure to temperature changes and exposure to a solvent (e.g., titanium, etc.).

Also shown in FIGS. 5 and 6, an upstream coupling mechanism 208 includes a first valve 210 and a second valve 212 that are disposed between gas chamber 202 and material chamber 204 for selectively coupling (i.e., fluidly coupling) the gas chamber to the material chamber. A downstream coupling mechanism 214 including a valve 216 is disposed between material chamber 204 and recovery chamber 206 for selectively coupling (i.e., fluidly coupling) the material chamber to the recovery chamber.

In the present example, each of the valves are ball valves. It will be appreciated that in alternative embodiments the upstream coupling mechanism can include more or fewer valves (e.g., 1, 3, etc.) and the downstream coupling mechanism can include more valves (e.g., 2, 3, etc.). Additionally or alternatively, one or more of the valves can be any type of valve known or yet to be discovered that is suitable for selective fluid coupling (e.g., ball valve, check valve, diaphragm valve, gate valve, globe valve, needle valve, plug valve, etc.).

As shown in FIGS. 5-7, recovery chamber 206 includes a lid 218 that is selectively coupled to a receptacle 220 via a tightenable and releasable attachment mechanism 222. In the present example, attachment mechanism 222 includes four threaded members 224 (only three threaded members are visible in the view of FIG. 1) that are rotatably attached to receptacle 220 and are fitted into complimentarily configured channels 226 on a periphery of lid 218. Receptacle 220 is substantially encompassed and/or encircled by a temperature regulating sleeve 221. Recovery chamber 106 further includes four foot members 228 (only two are visible in the view of FIG. 1) attached at a bottom edge periphery of sleeve 221.

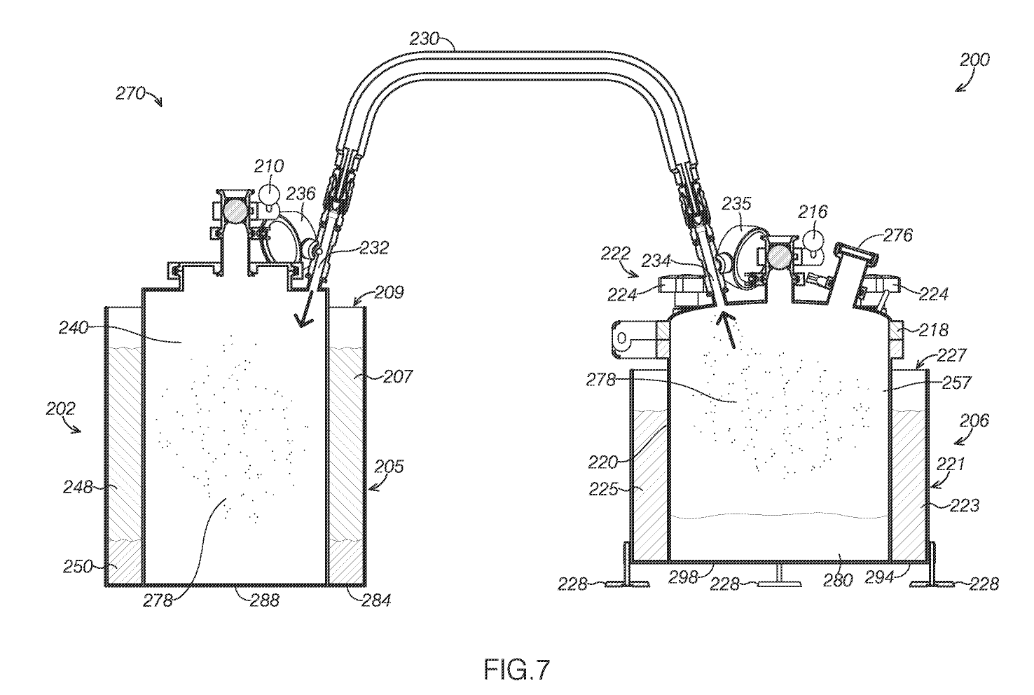

A hose 230 can be attached to a port 232 in gas chamber 202 and a port 234 in recovery chamber 206 (shown in FIG. 7). A pressure gauge 236 is coupled to port 232 for measuring an internal pressure of gas chamber 202 and a pressure gauge 235 is coupled to port 234 for measuring an internal pressure of recovery chamber 206.

As depicted in FIG. 6, during an extraction process 268, the gas, the material, and the recovery chambers are vertically arranged and gravity may act to pull liquids through the system. Accordingly, gas chamber 202 is configured to receive and/or retain a liquid solvent 238 (e.g., butane, butane, N-butane, hexane, alcohol, liquid oxygen, liquid nitrogen, liquid carbon dioxide, etc.) in an internal space 240, and is further configured to selectively dispense solvent 238. Solvent 238 can be fed into gas chamber 202 through hose 230 and/or port 232 (i.e., hose 230 can be removed and/or uncoupled from recovery chamber 206). Valves 210 and 212 are configured to regulate a flow of solvent 238 from gas chamber 202 to material chamber 204.

Further, gas chamber 202 includes sleeve 205 having an external space 207 that is configured to regulate a temperature of gas chamber 202 (i.e., a temperature within internal space 240). Accordingly, as shown in FIG. 7, external space 207 is configured to receive and retain a temperature regulating material, such a coolant 248 (e.g., solid carbon dioxide, liquid nitrogen, etc.) and/or a carrier solution 250 (e.g., liquid water, ethylene glycol, acetone, alcohol, etc.) during a passive solvent removal process 270. In alternate examples, the sleeve can be filled with a malleable heating material (e.g., hot water, hot sand, hot glycerin, hot buckwheat, etc.) for increasing the temperature of the gas chamber.

In the present example, external space 207 is open to the environment and has an opening 209 at a top of external space 207 and sleeve 205 for addition/insertion of temperature regulating materials when the gas chamber is in an inverted position (as depicted in FIG. 7). In alternate examples, external space 217 can be closed and include a port for addition of temperature regulating materials and/or release of gas.

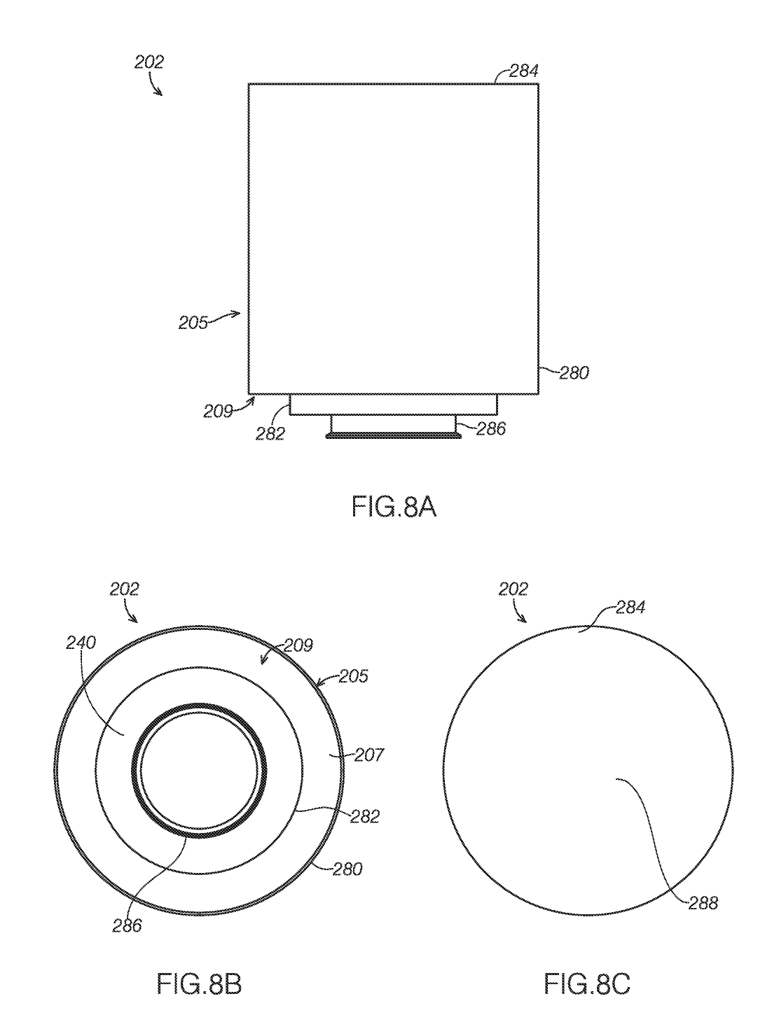

Detailed views of gas chamber 202 are shown in FIGS. 8A-8C. Gas chamber 202 includes an outer wall 280 that defines an outer periphery of sleeve 205 and opening 209. An internal wall 282 defines an outer periphery of internal space 240 and an inner wall of sleeve 205. On an opposing end of external space 207 relative to opening 209, gas chamber 202 includes a floor 284 of sleeve 205. A downstream coupling region 286 of gas chamber 202 is extended beyond sleeve 205 (i.e., extended beyond opening 209). Floor 284 is continuous with a floor 288 of gas chamber 202 (i.e. a top surface of the gas chamber is substantially flat). It will be appreciated that in some examples, the top surface and/or top periphery of the gas chamber can include foot members or cushioning pads to support inversion of the gas chamber during passive solvent removal, as depicted in FIG. 7.

Returning to FIG. 6, material chamber 204 is configured to receive and retain raw material 242 (e.g., plant material) in an internal space 244. Further, material chamber 204 is configured to receive solvent 238 from gas chamber 202 and form a mixture of solvent 238 and raw material 242 (i.e., an essential oil, contaminant, and solvent mixture). During extraction process 268, the mixture of solvent 238 and raw material 242 can be incubated in material chamber 204 for any desired length of time (described later in reference to FIG. 11).

Further, material chamber 204 includes sleeve 245 having an external space 246. Sleeve 245 is configured to regulate a temperature of material chamber 204 (i.e., a temperature within internal space 244). Accordingly, external space 246 is configured to receive and retain a temperature regulating material, such a coolant 248 (e.g., solid carbon dioxide, liquid nitrogen, etc.) and/or a coolant activating solution 250 (e.g., isopropyl alcohol, etc.) for cooling material chamber 204. In alternate examples, the sleeve can be filled with a malleable heating material (e.g., hot water, hot sand, hot glycerin, hot buckwheat, etc.) for increasing the temperature of the material chamber.

In the present example, external space 246 is open to the environment and has an opening 252 at a top of external space 246 and sleeve 245 for addition/insertion of temperature regulating materials. In alternate examples, the external space can be closed and include a port for addition of temperature regulating materials and/or release of gas.

Furthermore, material chamber 204 includes a filter 254 disposed at a downstream end (i.e., bottom) of internal space 244. Filter 254 is configured to filter and/or retain one or more contaminants (e.g., debris, plant matter, frozen plant matter particles, etc.) from the essential oil, contaminant, and solvent mixture, and permit passage of an oil and solvent solution 256 into recovery chamber 206. In one specific example, the filter is 254 mesh stainless steel screen.

In alternate examples, the material chamber can include more than one filter and/or the one or more filters can be comprised of a different filtration material (e.g., diatomaceous earth, paper, carbon charcoal, graphite, etc.). In examples where distillation system 200 includes a secondary material chamber, one or more filters may be disposed at one or both of the upstream end and the downstream end of the secondary material chamber.

Detailed views of material chamber 204 are shown in FIGS. 4A-4C. Material chamber 204 includes an outer wall 258 that defines an outer periphery of sleeve 245 and opening 252. An internal wall 260 defines an outer periphery of internal space 244 and an inner wall of sleeve 245. On an opposing end of external space 246 relative to opening 252, material chamber 204 includes a floor 262 of sleeve 245. An upstream coupling region 264 and a downstream coupling region 266 of material chamber 204 are extended beyond sleeve 245 (i.e., extended beyond opening 252 and floor 262, respectively).

Returning to FIG. 6, recovery chamber 206 is configured to receive oil and solvent mixture 256 from material chamber 204. Oil and solvent solution 256 is received and retained within internal space 257. Valve 216 is configured to regulate a flow of oil and solvent solution 256 from material chamber 204 to recovery chamber 206.

Further, recovery chamber 206 includes sleeve 221 having an external space 223 that is configured to regulate a temperature of recovery chamber 206 (i.e., a temperature within internal space 257). As shown in FIG. 7, the gas chamber and the recovery chamber can be uncoupled from the material chamber, the gas chamber can be inverted, and the gas chamber and the recovery chamber can be horizontally aligned during a passive solvent removal process 270. In this example, external space 223 is configured to receive and retain a temperature regulating material, such as a malleable heating material 225 (e.g., hot water, hot sand, hot glycerin, hot buckwheat, etc.). In alternate examples, the external space of the recovery chamber can be filled with a coolant (e.g., solid carbon dioxide, liquid nitrogen, etc.) and/or a carrier solution (e.g., liquid water, ethylene glycol, acetone, alcohol, etc.).

During passive solvent removal 270, the solvent can be removed from the oil and solvent mixture and returned to the gas chamber via hose 230. In one specific example, the hose includes a quick disconnect male coupling partner and each of the ports (e.g., ports 232 and 234) are quick disconnect female coupling partners. In this example, a slider can be moved outward on the female coupling partner to move an internal bearing out of a central channel of the female coupling partner. The male coupling partner can then be inserted into the central channel of the female coupling partner. When the male coupling partner is connected to the female coupling partner the bearings and the slider are biased to return towards an uncoupled position. The bearings are then abutted to a ridge on the male coupling partner. Once the ridge is slid past the bearings, the slider shuts via a spring, thereby locking the male coupling partner into the female coupling partner. A plug inside of the female coupling partner is pushed with a backpressure spring so that the connection pathway is opened and liquid and/or gases can pass freely through the coupled male and female coupling partners. The male and female coupling partners can be selectively uncoupled and/or released to close the ports and prevent movement of liquids and/or gases out of the chambers.

In the example of FIG. 7, heating material 225 is provided to increase a temperature and a pressure inside internal space 257 and coolant 248 and carrier solution 250 are provided to decrease a temperature inside internal space 240, creating a pressure and temperature gradient. Accordingly, solvent fumes 278 are driven down the temperature gradient and move from recovery chamber 206 to gas chamber 202, leaving a purified essential oil 280 (i.e., an end product) in the recovery chamber.

Passive solvent removal process 270 is characterized as “passive” because it does not require a pump system for solvent removal. Alternatively, in other examples for solvent removal, solvent fumes can be vented into a fumigation hood via port 234 (i.e., in an example excluding hose 230) or solvent fumes can be evacuated using active solvent removal (described above in reference to FIG. 3). After transfer of solvent fumes 278, purified essential oil 280 remains in recovery chamber 206 and solvent 278 is collected in gas chamber 202. The purified essential oil can be collected from the recovery chamber and/or the solvent in the gas chamber can be reused in subsequent extraction procedures.

In the present example, external space 223 is open to the environment and has an opening 227 at a top of external space 223 and sleeve 221 for addition/insertion of temperature regulating materials. In alternate examples, external space 223 can be closed and include a port for addition of temperature regulating materials and/or release of gas.

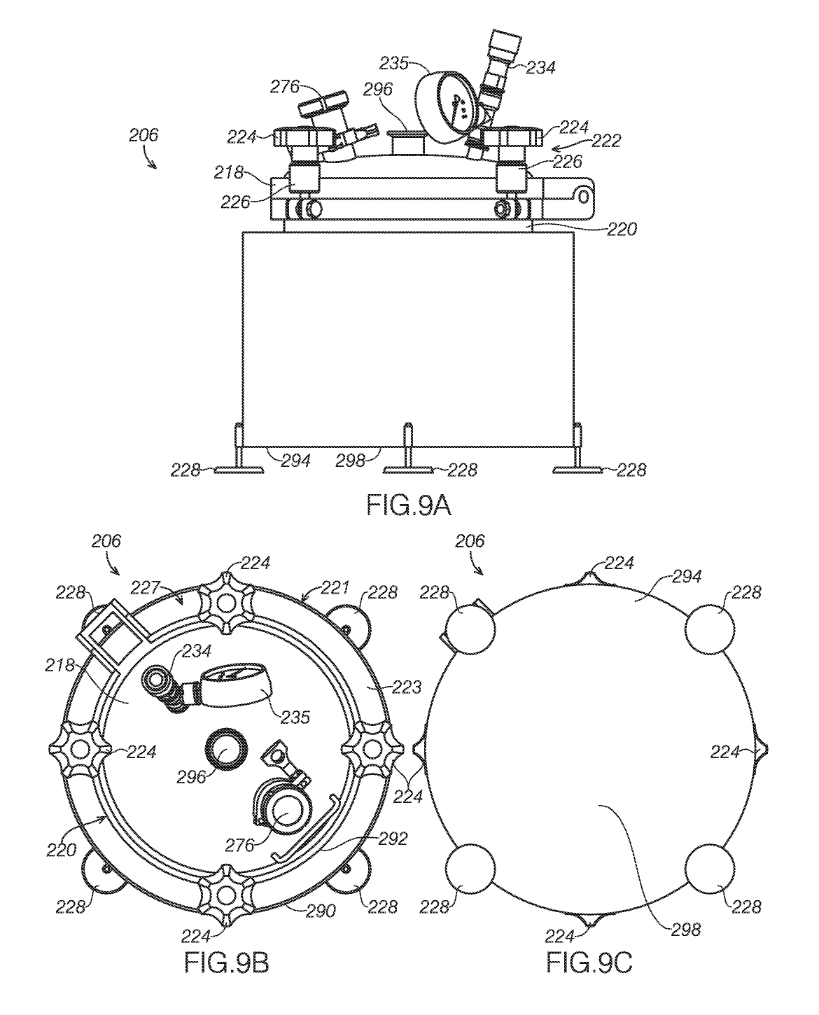

Detailed views of recovery chamber 206 are shown in FIGS. 9A-9C. Gas chamber 202 includes an outer wall 290 that defines an outer periphery of sleeve 221 and opening 227. An internal wall 292 defines an outer periphery of internal space 257 and an inner wall of sleeve 221. On an opposing end of external space 223 relative to opening 227, recovery chamber 206 includes a floor 294 of sleeve 221. An upstream coupling region 296 of recovery chamber 206 is extended beyond a top of lid 218. Floor 294 is continuous with a floor 298 of recovery chamber 206 (i.e. a bottom surface of the recovery chamber is substantially flat).

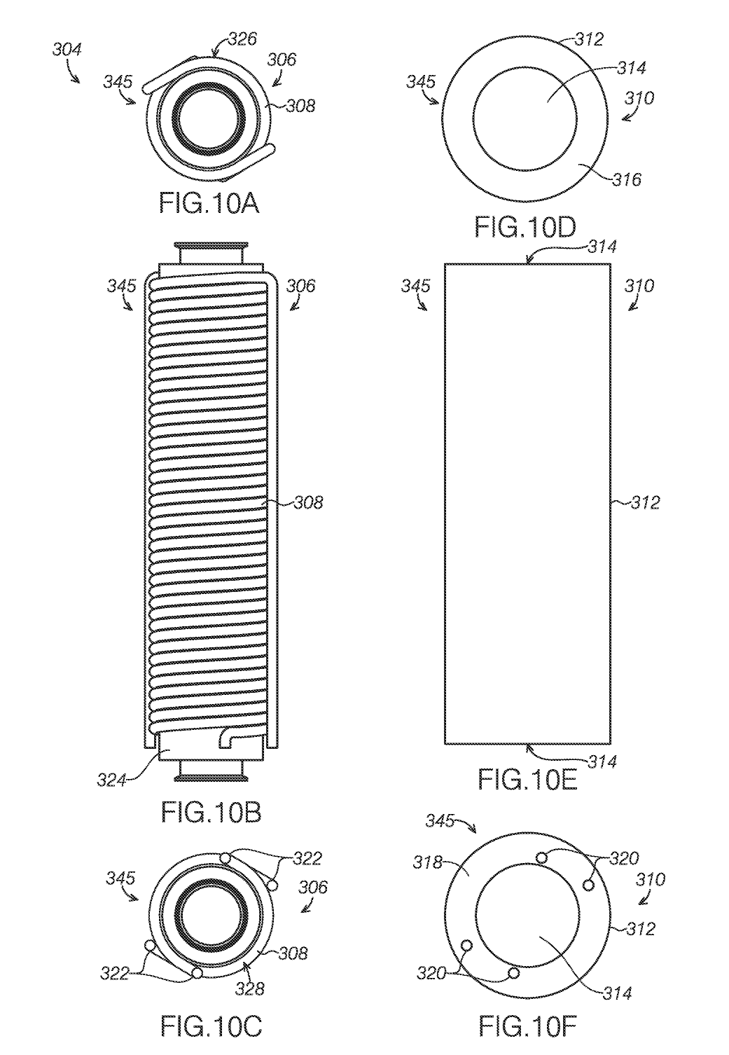

Turning now to FIGS. 10A-10F, a second example of a material chamber, a material chamber 304, is shown that can alternatively be used with either distillation systems 100 and 200 (i.e., material chamber 304 can be used in the system instead of material chamber 104/204). Material chamber 304 includes many similar or identical features to material chamber 104/204. Thus, for the sake of brevity, each feature of material chamber 304 will not be redundantly explained. Rather, key distinctions between material chamber 304 and material chamber 104/204 will be described in detail and the reader should reference the discussion above for features substantially similar between the two distillation systems.

Like material chamber 104, material chamber 304 includes a temperature regulating sleeve 345; however, instead of having a space for receiving a temperature regulating material, temperature regulating sleeve 345 includes a temperature regulating electrical element 306. Electrical element 306 has a plurality of coils 308 that are comprised of a metallic material and/or another material capable of heat transfer and contact an outer surface 324 of an internal space of the material chamber (the internal space being substantially identical to internal space 144 and 244 shown in FIGS. 2 and 6, respectively). The coils are configured to alternatively heat and/or cool the material chamber.

Further, sleeve 345 includes an outer casing 310 having an outer wall 312 that encompasses a space 314. Electrical element 306 is configured to be enclosed within space 314. Outer casing 310 has a top lip 316 that can be extended over a top end 326 of electrical element 306 and a bottom lip 318 that can be extended over a bottom end 328 of electrical element 316. Bottom lip 318 includes openings 320 where electrical components can be coupled to coupling ends 322 of coils 308.

It will be appreciated that material chamber 304 includes other components that are substantially similar to those of material chambers 104 and 204. It will be further appreciated that material chamber 304 can be operated and associated/coupled with either of distillation systems 10X) and 200 in a substantially similar manner as material chambers 104 and 204 (as described above and depicted in FIGS. 2 and 6, respectively).

Turning now to FIGS. 11A-11F, a third example of a material chamber, a material chamber 404, is shown that can alternatively be used with either distillation systems 100 and 200 (i.e., material chamber 404 can be used in the system instead of material chamber 104/204). Material chamber 404 includes many similar or identical features to material chamber 104/204. Thus, for the sake of brevity, each feature of material chamber 404 will not be redundantly explained. Rather, key distinctions between material chamber 404 and material chamber 104/204 will be described in detail and the reader should reference the discussion above for features substantially similar between the two distillation systems.

Like material chamber 104, material chamber 404 includes a temperature regulating sleeve 445; however, instead of having a space for receiving a solid temperature regulating material, temperature regulating sleeve 445 includes a dry ice collecting filter 406. As shown in FIGS. 11D-11F, filter 406 is generally cylindrical in shape and includes a centrally disposed space 408 so that it can be inserted into and contained within external space 446. A top wall 416 of sleeve 445 includes a port 412 where a hose can be selectively attached for transfer of liquid carbon dioxide into external space 446.

Accordingly, liquid carbon dioxide can be transferred into the external space via the hose and the port. After transfer into the external space, the liquid carbon dioxide undergoes a rapid pressure change (e.g., from around 840 psi to atmospheric pressure), which causes at least some of the carbon dioxide to expand into small crystals (i.e., flakes). The carbon dioxide crystals attach to and accumulate on the filter. Overtime, a solid block of carbon dioxide (i.e., dry ice) forms on the filter.

In the present example shown in FIGS. 11A-11C, an outer surface of sleeve 445 includes handles 414 and openings 420 (i.e., vertical elongate slits). Handles 414 are configured to allow manipulation of material chamber 404, which can be heavy when a large amount of dry ice has formed on the filter. Openings 420 are configured to allow carbon dioxide vapors that do not decompress and/or crystallize to escape from the chamber. Further, openings 420 are configured to allow for evaporation of solid carbon dioxide. In alternate examples, the material chamber and sleeve can exclude the handles. Additionally or alternatively, the openings can have a different shape, configuration, and/or location (e.g., perforations, horizontal slits, angled vents, on any of the side wall and/or top and bottom walls 416 and 418, etc.).

It will be appreciated that material chamber 404 includes other components that are substantially similar to those of material chambers 104 and 204. It will be further appreciated that material chamber 404 can be operated and associated/coupled with either of distillation systems 100 and 200 in a substantially similar manner as material chambers 104 and 204 (as described above and depicted in FIGS. 2 and 6, respectively).

In both of the above alternate examples for a material chamber (i.e., material chambers 304 and 404), a user can carry out essential oil extraction at cold temperatures for a longer time than by adding one load of preformed dry ice to the sleeve. Further, direct handling of dry ice by a user can be avoided.

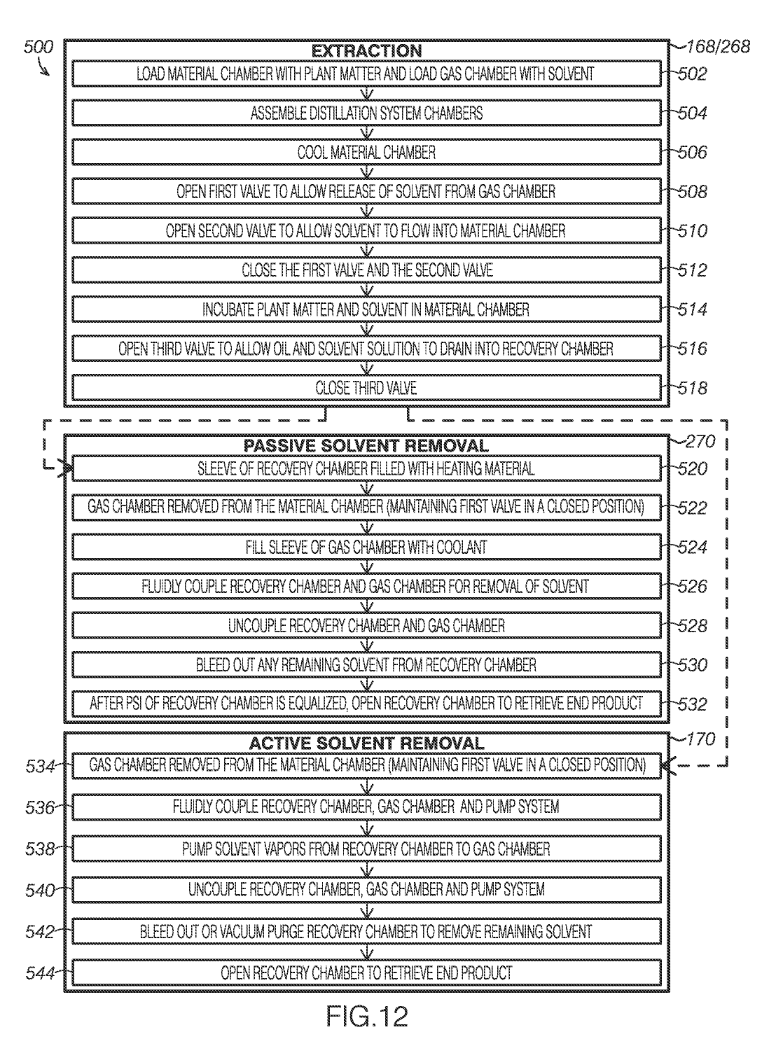

Lastly, FIG. 12 shows a method 500 for extraction and solvent removal using either of distillation systems 100 and 200. Method 500 includes an extraction method (i.e., extraction processes 168/268) in steps 502-518. Further, method 500 includes alternative methods for solvent removal, passive solvent removal (i.e., passive solvent removal process 270) in steps 520-532 and active solvent removal (i.e., active solvent removal process 170) in steps 534-544.

Extraction and active solvent removal can be carried out with either of distillation systems 100 and 200 (as depicted in FIGS. 2, 3, and 6). Passive solvent removal can be carried out with distillation system 200 (as depicted in FIG. 7). It will be appreciated that although only distillation system 100 is shown attached to a pump system (i.e., pump system 172 in FIG. 3) for active solvent removal, that distillation system 200 can also be attached to a pump system for active solvent removal in a substantially similar manner as distillation system 100.

In order to carry out extraction, first, at step 502, the material chamber is loaded with plant material and the gas chamber is loaded with solvent. The plant material may be raw or may be prepared for extraction (e.g., boiling, masticating, grinding, shredding, etc.). The solvent can be loaded through a hose or a port in fluid communication with an internal space of the gas chamber. After the plant material and the solvent are loaded into their respective chambers, the distillation system chambers are assembled in step 504. The distillation system chambers are assembled so that the gas chamber is upstream relative to the material chamber and the material chamber is upstream relative to the recovery chamber, as depicted in FIGS. 2 and 6. During loading and assembly, all valves are maintained in a closed position.

After assembly of the distillation system chambers, the first valve is opened to release solvent from the gas chamber and the second valve is opened to allow solvent to flow into the material chamber, at steps 508 and 510, respectively. After the solvent is released and/or pulled down into the material chamber, the first and the second valve are closed at step 512. It will be appreciated that in some alternative methods, the first and the second valve can be opened substantially simultaneously.

The material chamber sleeve is at least partially filled with a coolant material (e.g., solid carbon dioxide, liquid nitrogen, liquid carbon dioxide, etc.). Additionally, a carrier solution (e.g., liquid water, ethylene glycol, acetone, alcohol, etc.) may be added to the material chamber sleeve to further reduce the temperature of the essential oil, contaminant, and solvent mixture within the material chamber. Alternatively, for a material chamber including a temperature regulating electrical element, a temperature of the electrical element can be reduced. The essential oil, contaminant, and solvent mixture within the material chamber is reduced to a temperature between 0° C. and −40° C. Further, a pressure in the material chamber is reduced to −30 to 125 psi.

The essential oil, contaminant, and solvent mixture is then incubated in the cooled material chamber at step 514. The duration of incubation is any length of time desired by an operator. Further, the temperature and duration of incubation can be optimized for a specific plant material and essential oil. Once the essential oil, contaminant, and solvent mixture is cooled (i.e., contaminants are frozen), the third valve is opened (i.e., the valve between the material chamber and the recovery chamber) and the solvent and essential oil solution is released and/or drained into the recovery chamber at step 516. During release and/or draining of the solvent and essential oil solution, the solution is passed through a filter at the downstream end of the material chamber to remove frozen plant material, debris, particles, etc. After the solvent and essential oil solution is transferred to the recovery chamber, the third valve is closed at step 518.

It will be appreciated that in alternate example systems including primary and secondary material chambers, a gas chamber can be coupled to an upstream end of the primary material chamber, the secondary material chamber can be coupled to the downstream end of the primary material chamber, and a recovery chamber can be coupled to the downstream end of the secondary material chamber. The raw plant material can be loaded into the primary material chamber and a solvent can be dispensed from the gas chamber to the primary material chamber. One or more of the primary and the secondary material chambers can be cooled via one of the methods described above to freeze contaminants in the essential oil, contaminant, and solvent mixture. The mixture can be passed through a first filter in the primary material chamber and a second filter in the secondary material chamber to filter contaminants from the essential oil, contaminant, and solvent mixture. A solvent and essential oil solution can be collected from the secondary material chamber into the recovery chamber. It will be further appreciated that any number of material chambers can be included (i.e., any number of freezing and filtration passages) to increase a purity of the solvent and essential oil solution before it is collected in the recovery chamber.

After recovery of the solvent and essential oil solution, the solvent can be removed from the solution. Solvent removal can alternatively and/or selectively be carried out using passive solvent removal (with distillation system 200) or active solvent removal (with either of distillation systems 100 and 200) methods. Passive solvent removal has the advantage that a pump system and/or electricity are not required. Active solvent removal has the advantage that coolant and/or heating materials are not required. Additionally, temperature regulating sleeves on the recovery chamber and the gas chamber are not required.

For passive solvent removal, first, at step 520, the sleeve of the material chamber is filled with a malleable heating material (e.g., hot water, hot sand, hot glycerin, hot buckwheat, etc.), increasing a temperature of the recovery chamber at least an evaporating point of the solvent (e.g., at least to a temperature of 8° C. to evaporate a butane solvent). Further, a pressure within the recovery chamber can be increased. In one specific example, the pressure of the recovery chamber is increased to −30 to 125 psi.

Next, at step 522, the gas chamber is removed from the material chamber and inverted. The gas chamber is placed in a location proximal to the recovery chamber and the first valve is maintained in a closed position. It will be appreciated that in alternate examples, the gas chamber can be removed prior to adding the heating material to the recovery chamber sleeve. It will be further appreciated that the material chamber can be removed from the recovery chamber while the third valve is maintained in a closed position (as depicted in FIG. 7).

After removal of the gas chamber from the material chamber, the gas chamber sleeve is at least partially filled with a coolant material (e.g., solid carbon dioxide, liquid nitrogen, etc.) at step 424. Additionally, a carrier solution (e.g., liquid water, ethylene glycol, acetone, alcohol, etc.) may be added to the gas chamber sleeve to further reduce the temperature and/or lower the pressure of the gas chamber. In one specific example, the temperature of the gas chamber can be lowered to 0° C. to −40° C., and the pressure of the gas chamber can be reduced to −30 to 125 psi. In other examples, the pressure and/or the temperature can be lower or higher.

At step 526, the gas chamber is fluidly coupled to the recovery chamber. A hose (e.g., a braided hose) is coupled to at a first end to a port of the gas chamber and a second end of the hose is coupled to a port of the recovery chamber. It will be appreciated that in some alternate examples, the hose can remain connected (i.e., be connected prior to the solvent removal process) and the ports of the gas chamber and the recovery chamber can be selectively opened and closed to allow fluid communication and disable fluid communication between the recover chamber and the gas chamber, respectively. Once the recovery chamber and the gas chamber are in fluid communication (i.e., coupled by a hose), the solvent fumes (i.e., vapors) move from the higher temperature/higher pressure recovery chamber to the lower temperature/lower pressure gas chamber.

After the solvent fumes have been removed from the recovery chamber, the recovery chamber and the gas chamber are uncoupled (e.g., the hose is removed from the ports and/or the ports are closed) at step 528. Any remaining solvent fumes can be bled from the recovery chamber via one of the ports of the recovery chamber at step 530. As the pressure of the recovery chamber is reduced to atmospheric pressure (i.e., a reading of 0 PSI), the lid of the recovery chamber can be opened and the purified essential oil (i.e., the end product) can be removed and/or collected at step 532.

Alternatively, for active solvent removal, at step 534 the gas chamber is removed from the material chamber and inverted. The gas chamber is placed in a location proximal to the recovery chamber and the first valve is maintained in a closed position. It will be appreciated that the material chamber can be removed from the recovery chamber while the third valve is maintained in a closed position (as depicted in FIG. 3).

After removal of the gas chamber from the material chamber, at step 536, the gas chamber is fluidly coupled a pump system and the pump system is further fluidly coupled to the recovery chamber. A hose (e.g., a braided hose) is coupled to at a first end to a port of the gas chamber and a second end of the hose is coupled to a port (i.e., a first port) of the pump system. Further, another hose (e.g., a braided hose) is coupled to at a first end to a port (i.e., a second port) of the pump system and a second end of the hose is coupled to a port of the recovery chamber. It will be appreciated that in some alternate examples, the pump system can be attached to only the gas chamber and the gas chamber can be directly coupled to the recovery chamber. In this example, the pump is used to create a vacuum in the gas chamber. It will be appreciated that in other alternate examples, the pump system can be attached only to the recovery chamber and the recovery chamber can be directly coupled to the gas chamber. In this example, the pump is used to increase a pressure in the recovery chamber.

Returning to FIG. 12, after coupling of the recovery chamber and the gas chamber (i.e., coupled by a hose), and the pump system, the pump system is activated and solvent fumes (i.e., solvent vapors) are pumped from the recovery chamber to the gas chamber at step 538. After the solvent fumes have been removed from the recovery chamber, the recovery chamber, the gas chamber, and the pump system are uncoupled (e.g., the hoses are removed from the ports and/or the ports are closed) at step 540. Any remaining solvent fumes can be bled from the recovery chamber via one of the ports of the recovery chamber and/or the recovery chamber can be vacuum purged via reversing flow of the pump system at step 542. Then, the lid of the recovery chamber can be opened and the purified essential oil (i.e., the end product) can be removed and/or collected at step 544.

The inventions described in this application may be made by a variety of industrial processes, including by various techniques for essential oil extraction and/or solvent removal from a solvent and essential oil solution during essential oil distillation. Further, the inventions described herein may be used in industrial contexts, including essential oil purification/distillation endeavors.

The inventions described above may be alternatively described according to the following non-limiting embodiments:

In a first embodiment for essential oil distillation system for purifying an essential oil from plant material, the essential oil distillation system may include a material chamber, the material chamber configured to receive plant material and a solvent during an extraction process, a combination of the plant material and the solvent being an essential oil, contaminant, and solvent mixture; a temperature regulating sleeve, the temperature regulating sleeve configured to be cooled to decrease a temperature of the oil, contaminant, and solvent mixture and freeze one or more contaminants in the oil, contaminant, and solvent mixture during the extraction process; at least one filter configured to filter the one or more contaminants from the essential oil, contaminant, and solvent mixture to separate a solvent and essential oil solution from the one or more contaminants during the extraction process; and a recovery chamber, the recovery chamber being fluidly coupled to a downstream end of the material chamber, the recovery chamber configured to receive the solvent and essential oil solution during the extraction process.

In some examples of the first embodiment for an essential oil distillation system, the temperature regulating sleeve may be disposed on an outer surface of the material chamber. In examples where the temperature regulating sleeve is disposed on an outer surface of the material chamber, the temperature regulating sleeve may be configured to substantially encompass the material chamber.

In some examples of the first embodiment for an essential oil distillation system, the coolant may be solid carbon dioxide. In examples where the coolant is solid carbon dioxide, the coolant may be suspended in a carrier solution, the carrier solution being one or more of liquid water, ethylene glycol, acetone, and alcohol.

In some examples of the first embodiment for an essential oil distillation system, the temperature regulating sleeve may be configured to generate a coolant, the coolant being solid carbon dioxide.

In some examples of the first embodiment for an essential oil distillation system, the solvent may be butane.

In some examples of the first embodiment for an essential oil distillation system, the essential oil distillation system may further include a gas chamber, the gas chamber being coupled to an upstream end of the material chamber and configured to receive the solvent and selectively dispense the solvent to the material chamber during the extraction process. In examples where the essential oil distillation system further includes a gas chamber, the gas chamber may be further configured to be uncoupled from the material chamber and coupled to the recovery chamber during a solvent removal process. In examples where the essential oil distillation system further includes a gas chamber and the gas chamber is configured to be uncoupled from the material chamber and coupled to the recovery chamber during a solvent removal process, the gas chamber may be further configured to receive solvent vapors from the recovery chamber during the solvent removal process. In examples where the essential oil distillation system further includes a gas chamber and the gas chamber is configured to be uncoupled from the material chamber, coupled to the recovery chamber during a solvent removal process, and to receive solvent vapors from the recovery chamber during the solvent removal process, the essential oil distillation system may further a pump system coupled to the recovery chamber and the gas chamber during the solvent removal process, the pump system being configured to pump the solvent vapors from the recovery chamber to the gas chamber, the solvent removal process being an active solvent removal process.

In some examples of the first embodiment for an essential oil distillation system, the essential oil distillation system may further include a gas chamber, the gas chamber being coupled to an upstream end of the material chamber and configured to receive the solvent and selectively dispense the solvent to the material chamber during the extraction process. In examples where the essential oil distillation system further includes a gas chamber, the gas chamber may be further configured to be uncoupled from the material chamber and coupled to the recovery chamber during a solvent removal process. In examples where the essential oil distillation system further includes a gas chamber and the gas chamber is configured to be uncoupled from the material chamber and coupled to the recovery chamber during a solvent removal process, the gas chamber may be further configured to receive solvent vapors from the recovery chamber during the solvent removal process. In examples where the essential oil distillation system further includes a gas chamber and the gas chamber is configured to be uncoupled from the material chamber, coupled to the recovery chamber during a solvent removal process, and to receive solvent vapors from the recovery chamber during the solvent removal process, the temperature regulating sleeve may be a material chamber sleeve and the gas chamber may further include a gas chamber sleeve configured to receive a coolant to decrease a gas chamber temperature and pressure during the solvent removal process. In examples where the essential oil distillation system further includes a gas chamber and the gas chamber is configured to be uncoupled from the material chamber, coupled to the recovery chamber during a solvent removal process, and to receive solvent vapors from the recovery chamber during the solvent removal process, the temperature regulating sleeve is a material chamber sleeve and the gas chamber further includes a gas chamber sleeve configured to receive a coolant to decrease a gas chamber temperature and pressure during the solvent removal process, the recovery chamber may further include a recovery chamber sleeve configured to receive a heating material to increase a recovery chamber temperature and pressure during the solvent removal process. In examples where the essential oil distillation system further includes a gas chamber and the gas chamber is configured to be uncoupled from the material chamber, coupled to the recovery chamber during a solvent removal process, and to receive solvent vapors from the recovery chamber during the solvent removal process, the temperature regulating sleeve is a material chamber sleeve, the gas chamber further includes a gas chamber sleeve configured to receive a coolant to decrease a gas chamber temperature and pressure during the solvent removal process, and the recovery chamber further includes a recovery chamber sleeve configured to receive a heating material to increase a recovery chamber temperature and pressure during the solvent removal process, the decreased gas chamber temperature and pressure and the increased recovery chamber temperature and pressure may be a pressure and temperature gradient that drives movement of solvent fumes from the recovery chamber to the gas chamber, the solvent removal process being a passive solvent removal process.

In some examples of the first embodiment for an essential oil distillation system, the at least one filter may be disposed in a downstream end of the material chamber.

In a second embodiment for essential oil distillation system for purifying an essential oil from plant material, the essential oil distillation system may include a material chamber, the material chamber configured to receive plant material and a solvent during an extraction process, a combination of the plant material and the solvent being an essential oil, contaminant, and solvent mixture; a temperature regulating sleeve, the temperature regulating sleeve configured receive at least a coolant to decrease a temperature of the essential oil, contaminant, and solvent mixture and freeze one or more contaminants in the essential oil, contaminant, and solvent mixture during the extraction process; at least one filter configured to filter the one or more contaminants from the essential oil, contaminant, and solvent mixture to separate a solvent and essential oil solution from the one or more contaminants during the extraction process; a gas chamber fluidly coupled to an upstream end of the material chamber and configured to receive the solvent and selectively dispense the solvent to the material chamber during the extraction process; and a recovery chamber fluidly coupled to a downstream end of the material chamber, the recovery chamber configured to receive the solvent and essential oil solution during the extraction process.

In some examples of the second embodiment for an essential oil distillation system, the temperature regulating sleeve may disposed on an outer surface of the material chamber and substantially encompasses the material chamber.

In some examples of the second embodiment for an essential oil distillation system, the gas chamber may be configured to be uncoupled from the material chamber and coupled to the recovery chamber during a solvent removal process, the gas chamber being further configured to receive solvent vapors from the recovery chamber during the solvent removal process.

In some examples of the second embodiment for an essential oil distillation system, the system may further comprise a pump system coupled to the recovery chamber during the solvent removal process, the pump system being configured to pump the solvent vapors from the recovery chamber to the gas chamber, the solvent removal process being an active solvent removal process.

In some examples of the second embodiment for an essential oil distillation system, the temperature regulating sleeve may be a material chamber sleeve, the gas chamber may further comprise a gas chamber sleeve configured to receive a coolant to decrease a gas chamber temperature and pressure during the solvent removal process, and the recovery chamber may further comprise a recovery chamber sleeve configured to receive a heating material to increase a recovery chamber temperature and pressure during the solvent removal process, the solvent removal process being a passive solvent removal process.

In a third embodiment for essential oil distillation system for purifying an essential oil from plant material, the essential oil distillation system may include a material chamber, the material chamber configured to receive plant material and a solvent during an extraction process, a combination of the plant material and the solvent being an essential oil, contaminant, and solvent mixture; a temperature regulating sleeve configured to receive at least a coolant to decrease a temperature of the essential oil, contaminant, and solvent mixture and freeze one or more contaminants in the essential oil, contaminant, and solvent mixture during the extraction process; at least one filter configured to filter the one or more contaminants from the essential oil, contaminant, and solvent to separate a solvent and essential oil solution from the one or more contaminants during the extraction process; a recovery chamber, the recovery chamber being fluidly coupled to a downstream end of the material chamber, the recovery chamber configured to receive the solvent and essential oil solution during the extraction process; and a gas chamber, the gas chamber being coupled to an upstream end of the material chamber and configured to receive the solvent and selectively dispense the solvent to the material chamber during the extraction process, gas chamber being further configured to be uncoupled from the material chamber and coupled to the recovery chamber to receive solvent vapors from the recovery chamber during a solvent removal process.

In a first example method for distilling an essential oil, the method may include:

loading a material chamber with a plant material and loading a gas chamber with a solvent;

allowing solvent from the gas chamber to flow into the material chamber to form an essential oil, contaminant, and solvent mixture;

cooling a temperature regulating sleeve to decrease a temperature of the essential oil, contaminant, and solvent mixture;

incubating the essential oil, contaminant, and solvent mixture to freeze one or more contaminants in the essential oil, contaminant, and solvent mixture;

filtering the one or more contaminants from the essential oil, contaminant, and solvent mixture to create a solvent and essential oil solution;

collecting the solvent and essential oil solution into a recovery chamber; and

removing the solvent from the solvent and oil mixture to obtain a purified essential oil.

In a second example method for distilling an essential oil, the method may include:

coupling a gas chamber to an upstream end of a material chamber and coupling a recovery chamber to a downstream end of the material chamber;

loading the material chamber with a plant material and loading the gas chamber with a solvent;

filling a material chamber sleeve with a coolant for decreasing a temperature of the material chamber;

opening at least one upstream valve to allow fluid communication between the gas chamber and the material chamber, fluid communication allowing flow of the solvent from the gas chamber into the material chamber to create an essential oil, contaminant, and solvent mixture;

closing the at least one upstream valve;

incubating the essential oil, contaminant, and solvent mixture in the material chamber to freeze one or more contaminants in the plant material and solvent mixture;

opening at least one downstream valve to allow fluid communication between the material chamber and the recovery chamber, fluid communication allowing flow of the plant material and solvent mixture through at least one filter disposed within the material chamber, the at least one filter configured to filter the one or more contaminants and allow passage of a solvent and essential oil solution;

draining of the solvent and essential oil solution into the recovery chamber;

closing the at least one downstream valve; and

removing the solvent from the solvent and oil mixture to obtain a purified essential oil.

In some examples for the first or the second example methods, wherein removing the solvent from the solvent and oil solution is an active solvent removal method, the first example method may further include:

uncoupling the gas chamber from the material chamber and inverting the gas chamber;

coupling the gas chamber to the recovery chamber to a pump system to allow fluid communication between the gas chamber and the recovery chamber,

pumping solvent vapors from the recovery chamber to the gas chamber, the flow of solvent vapors from the recovery chamber to the gas chamber being driven by the pump system;

uncoupling the gas chamber, the recovery chamber and the pump system; and

collecting the purified essential oil from the recovery chamber.

In some examples for the first or the second example methods, wherein removing the solvent from the solvent and oil solution is a passive solvent removal method, the first example method may further include:

uncoupling the gas chamber from the material chamber and inverting the gas chamber;

filling a gas chamber sleeve with a coolant to decrease a gas chamber temperature and pressure of the and filling a recovery chamber sleeve with a heating material to increase a recovery chamber temperature and pressure;

coupling die gas chamber to the recovery chamber to allow fluid communication between the gas chamber and the recovery chamber, fluid communication allowing flow of solvent vapors from the recovery chamber to the gas chamber,

uncoupling the gas chamber and the recovery chamber, and

collecting the purified essential oil from the recovery chamber.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

2. An essential oil distillation system for purifying an essential oil from plant material, the essential oil distillation system comprising:
a material chamber, the material chamber configured to receive plant material and a solvent during an extraction process, a combination of the plant material and the solvent being an essential oil, contaminant, and solvent mixture;
a temperature regulating sleeve, the temperature regulating sleeve configured to be cooled to decrease a temperature of the oil, contaminant, and solvent mixture and freeze one or more contaminants in the oil, contaminant, and solvent mixture during the extraction process;
at least one filter configured to filter the one or more contaminants from the essential oil, contaminant, and solvent mixture to separate a solvent and essential oil solution from the one or more contaminants during the extraction process; and
a recovery chamber, the recovery chamber being fluidly coupled to a downstream end of the material chamber, the recovery chamber configured to receive the solvent and essential oil solution during the extraction process.

3. The essential oil distillation system of claim 1, wherein the temperature regulating sleeve is disposed on an outer surface of the material chamber.

4. The essential oil distillation system of claim 2, wherein the temperature regulating sleeve is configured to substantially encompass the material chamber.

5. The essential oil distillation system of claim 1, wherein the temperature regulating sleeve is configured to receive at least a coolant.

6. The essential oil distillation system of claim 4, wherein the coolant is solid carbon dioxide.

7. The essential oil distillation system of claim 5, wherein the temperature regulating sleeve is further configured to receive a carrier solution, the carrier solution being one or more of liquid water, ethylene glycol, acetone, and alcohol.

8. The essential oil distillation system of claim 1, wherein the temperature regulating sleeve is configured to generate a coolant, the coolant being solid carbon dioxide.

9. The essential oil distillation system of claim 1, wherein the solvent is butane.

10. The essential oil distillation system of claim 1, further comprising a gas chamber, the gas chamber being coupled to an upstream end of the material chamber and configured to receive the solvent and selectively dispense the solvent to the material chamber during the extraction process.

11. The essential oil distillation system of claim 9, wherein the gas chamber is further configured to be uncoupled from the material chamber and coupled to the recovery chamber during a solvent removal process to receive solvent vapors from the recovery chamber during the solvent removal process.

12. The essential oil distillation system of claim 10, further comprising a pump system coupled to the recovery chamber and the gas chamber during the solvent removal process, the pump system being configured to pump the solvent vapors from the recovery chamber to the gas chamber, the solvent removal process being an active solvent removal process.

13. The essential oil distillation system of claim 10, wherein the temperature regulating sleeve is a material chamber sleeve, the gas chamber further comprising a gas chamber sleeve configured to receive a coolant to decrease a gas chamber temperature and pressure during the solvent removal process, the solvent removal process being a passive solvent removal process.

14. The essential oil distillation system of claim 12, wherein the recovery chamber further comprises a recovery chamber sleeve configured to receive a heating material to increase a recovery chamber temperature and pressure during the passive solvent removal process.

15. The essential oil distillation system of claim 1, wherein at least one filter is disposed in a downstream end of the material chamber.

16. An essential oil distillation system for purifying an essential oil from plant material, the essential oil distillation system comprising:
a material chamber, the material chamber configured to receive plant material and a solvent during an extraction process, a combination of the plant material and the solvent being an essential oil, contaminant, and solvent mixture;
a temperature regulating sleeve, the temperature regulating sleeve configured receive at least a coolant to decrease a temperature of the essential oil, contaminant, and solvent mixture and freeze one or more contaminants in the essential oil, contaminant, and solvent mixture during the extraction process;
at least one filter configured to filter the one or more contaminants from the essential oil, contaminant, and solvent mixture to separate a solvent and essential oil solution from the one or more contaminants during the extraction process;
a gas chamber fluidly coupled to an upstream end of the material chamber and configured to receive the solvent and selectively dispense the solvent to the material chamber during the extraction process; and
a recovery chamber fluidly coupled to a downstream end of the material chamber, the recovery chamber configured to receive the solvent and essential oil solution during the extraction process.

17. The essential oil distillation system of claim 15, wherein the temperature regulating sleeve is disposed on an outer surface of the material chamber and substantially encompasses the material chamber.

18. The essential oil distillation system of claim 15, wherein the gas chamber is configured to be uncoupled from the material chamber and coupled to the recovery chamber during a solvent removal process, the gas chamber being further configured to receive solvent vapors from the recovery chamber during the solvent removal process.

19. The essential oil distillation system of claim 15, further comprising a pump system coupled to the recovery chamber during the solvent removal process, the pump system being configured to pump the solvent vapors from the recovery chamber to the gas chamber, the solvent removal process being an active solvent removal process.

20. The essential oil distillation system of claim 15, wherein the temperature regulating sleeve is a material chamber sleeve, the gas chamber further comprising a gas chamber sleeve configured to receive a coolant to decrease a gas chamber temperature and pressure during the solvent removal process, and
the recovery chamber further comprises a recovery chamber sleeve configured to receive a heating material to increase a recovery chamber temperature and pressure during the solvent removal process, the solvent removal process being a passive solvent removal process.

21. An essential oil distillation system for purifying an essential oil from plant material, the essential oil distillation system comprising:
a material chamber, the material chamber configured to receive plant material and a solvent during an extraction process, a combination of the plant material and the solvent being an essential oil, contaminant, and solvent mixture;
a temperature regulating sleeve configured to receive at least a coolant to decrease a temperature of the essential oil, contaminant, and solvent mixture and freeze one or more contaminants in the essential oil, contaminant, and solvent mixture during the extraction process;
at least one filter configured to filter the one or more contaminants from the essential oil, contaminant, and solvent to separate a solvent and essential oil solution from the one or more contaminants during the extraction process;
a recovery chamber, the recovery chamber being fluidly coupled to a downstream end of the material chamber, the recovery chamber configured to receive the solvent and essential oil solution during the extraction process; and
a gas chamber, the gas chamber being coupled to an upstream end of the material chamber and configured to receive the solvent and selectively dispense the solvent to the material chamber during the extraction process, gas chamber being further configured to be uncoupled from the material chamber and coupled to the recovery chamber to receive solvent vapors from the recovery chamber during a solvent removal process.
